(19) United States
(12) Patent Application Publication
(10) Pub. No.: US 2026/0259554 A1
(43) Pub. Date: Sep. 3, 2026

(54) SYSTEM AND METHOD FOR AUTOMATICALLY RECTIFYING DEVIATIONS ON A MACHINE LINE

(71) Applicant: Krones AG, Neutraubling (DE)

(72) Inventor: Christoph MICKO, Kümmersbruck (DE)

(21) Appl. No.: 19/549,633

(22) Filed: Feb. 25, 2026

(30) Foreign Application Priority Data
Mar. 3, 2025 (DE) 102025107962.5

(51) Int. Cl. G05B 19/418

(52) U.S. Cl. CPC G05B 19/41875; G05B 2219/33027; G05B 2219/37499

(57) ABSTRACT

The disclosure relates to a computer-implemented method, to a system and to a computer-readable storage medium for automatically rectifying deviations on a machine line. According to embodiments, the actual state of the machine line is monitored by means of a plant control system. This makes it possible to detect when a deviation occurs between the monitored actual state and an optimal state of the machine line. The plant control system determines a suitable response measure suitable for rectifying the deviation and forwards it to a large action model (LAM) unit, which derives a control command from the response measure and executes it on the machine line to rectify or minimize the deviation. Intervention information is then transmitted to a large language model (LLM) unit, which processes said information and issues a corresponding message regarding the deviation and the response measure to an operator.

### CROSS REFERENCE TO RELATED APPLICATION

The present application claims priority to German Patent Application No. 10 2025 107 962.5 filed on Mar. 03, 2025. The entire contents of the above-listed application are hereby incorporated by reference for all purposes.

### TECHNICAL FIELD

The disclosure relates to methods, systems and computer-readable storage media for automatically rectifying deviations on a machine line, for example a machine line for filling and packaging food and/or beverages.

### BACKGROUND

Manufacturing plants and machine lines typically comprise a plurality of interconnected machines that are functionally coupled and work together in a coordinated fashion to produce, package or fill products. Due to the high complexity of these plants, it is important to continuously monitor the operating state of the machines in order to ensure high production quality and avoid costly downtime or defects.

### SUMMARY

Monitoring of machine lines is generally primarily based on analyzing sensor data captured by the individual machines. The sensors measure physical quantities such as temperature, pressure, speed, current consumption, or vibrations. These captured data are compared in real time with predefined target values. This target-actual comparison serves to identify deviations from normal operation and to issue corresponding fault messages.

When deviations are detected, a previously created fault message is usually generated, which is based on fixed rules and threshold values. Such fault messages can, for example, provide indications of mechanical or electrical problems, limit values being exceeded or of other undesirable operating states. Typically, the fault messages are displayed on the machine user interfaces or on a computer used by operators to control the machine line. The messages are displayed to operators or maintenance technicians, who can then take appropriate action.

Although this monitoring system is effective in principle, it also has limitations and problems. One challenge consists in the fact that the rules and thresholds used are rigid and often only have limited adaptability. As a result, dynamic or complex operating states cannot always be adequately taken into account. Particularly in machine lines that are subject to high variability, for example due to changing products or unforeseen operating conditions, this can lead to false alarms or delayed detection of actual problems.

Another problem is that the previously created fault messages often provide only limited information about the causes of deviations. This can lead to operators and maintenance personnel having to spend a lot of time troubleshooting before they can take appropriate countermeasures. This significantly impairs troubleshooting efficiency, which is particularly detrimental in highly automated and time-critical production processes.

For this reason, there is a need for improved methods and systems for automatically rectifying deviations on a machine line, in particular a machine line for filling and packaging food and/or beverages.

This object is achieved according to the disclosure by a computer-implemented method, a system, and a computer-readable storage medium as described herein.

One embodiment relates to a computer-implemented method for automatically rectifying deviations on a machine line, for example a machine line for filling and packaging food and/or beverages. The method involves monitoring the actual state of the machine line by means of a plant control system. In this process, one or more parameters of the machine line are monitored to detect whether/that there is a deviation between the monitored actual state and an optimal state of the machine line. From this, the plant control system then determines a response measure that is suitable for rectifying the deviation. A large action model (LAM) unit derives one or more control commands therefrom and executes them on the machine line to rectify or minimize the deviation. The intervention information is then sent from the LAM unit to a large language model (LLM) unit which processes said information in order to send to the operator a message that opens up a conversation relating to the deviation and the response measure.

Further embodiments relate to a corresponding system and to a corresponding computer-readable storage medium.

### BRIEF DESCRIPTION OF THE FIGURES

Example aspects of the disclosure are shown in the drawings, In the figures:

FIG. 1: shows a diagram of a system comprising a machine line, in which embodiments of the disclosure are implemented;

FIG. 2: shows a block diagram illustrating an implementation of the disclosure;

FIG. 3: shows an exemplary plant configuration for PET containers and adhesive containers;

FIG. 4: shows an exemplary plant configuration for PET containers and shrink packers;

FIG. 5: shows an exemplary plant configuration for cans or glass bottles; and

FIG. 6: shows an exemplary plant configuration for cans.

### DETAILED DESCRIPTION

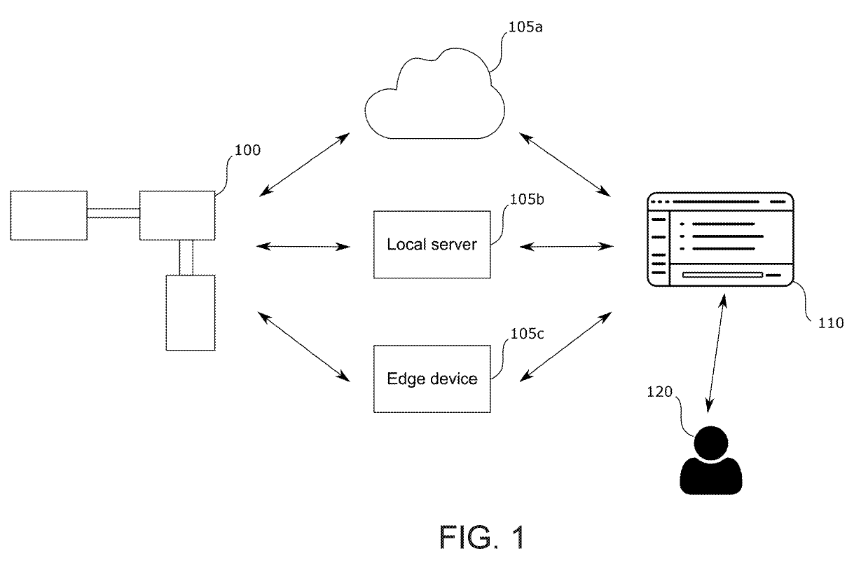

FIG. 1 shows an exemplary architecture of a machine line 100 and various components for human-machine interaction according to embodiments of the disclosure.

One aim of the disclosure is to provide improved human-machine interaction by means of one or more AI implementations. FIG. 1 shows an exemplary architecture in which the embodiments of the disclosure can be implemented. The steps in the embodiments usually take place in a computer apparatus 105, which operates between the machine line 100 itself and the operator 120 and provides this operator 120 with a user interface 110, such as an HMI.

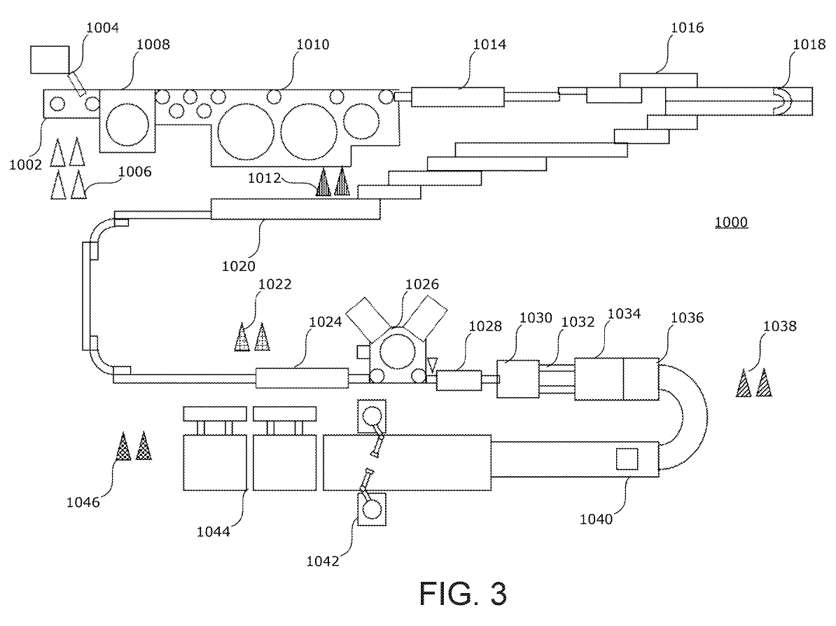

The machine line 100 can, for example, be a machine line for filling and packaging food and/or beverages, as described in more detail in FIGS. 3 to 6.

The computer apparatus 105 can be, for example, a cloud system 105a, a local server 105b located near the machine line 100 and/or an edge apparatus 105c, and can have the functionality thereof.

The exemplary computer apparatus 105 comprises a plurality of functional components that work together to allow the described disclosure to be carried out. The computer apparatus 105 comprises, for example, a memory for storing data and instructions required to carry out the disclosure. The memory can include a volatile and/or non-volatile storage medium, such as RAM, ROM, hard disk drives or solid-state memory.

A central processing unit or CPU, which serves as the main processor of the computer apparatus 105, can be used to process the data and carry out the instructions. The CPU is capable of performing complex calculations and logical decisions. It can be implemented as a single processor or as a multi-core processor to ensure higher processing efficiency. In addition to the CPU, one or more graphics processing units (GPUs) may also be provided, as many AI models typically run on such GPUs or, in the future, on special neural processors. For this reason, in addition to a classic CPU, other processors are also conceivable.

The HMI 110 can consist not only of hardware-based elements such as keyboards, touchscreens or physical switches, but also software-based interfaces provided via graphical user interfaces. This interface serves to receive inputs from the operator 120 and to provide outputs in a form understandable to the operator 120.

For communication with external equipment or networks, the computer apparatus 105 can be equipped with a communication module which can support wired or wireless connections, for example via Ethernet, WLAN, Bluetooth or mobile communication standards. The communication module makes it possible for data to be exchanged between the computer apparatus 105 and other systems, such as the machine line 100 itself, which may be particularly important for networked applications or cloud-based services.

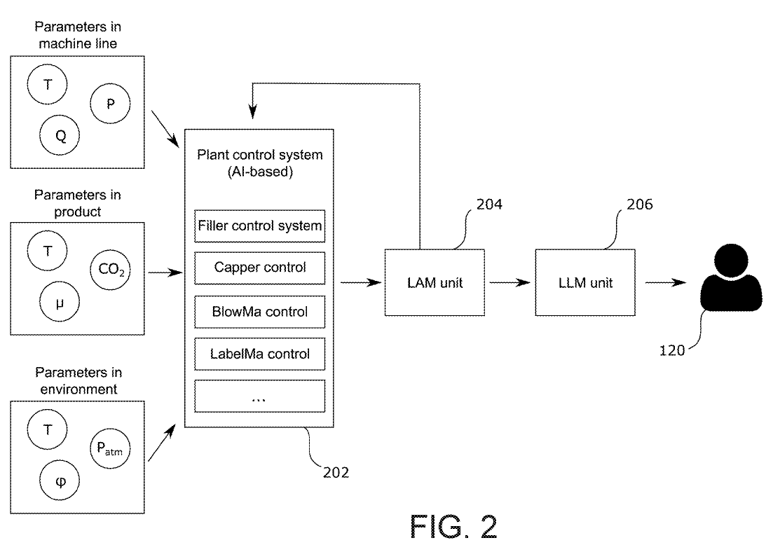

One or more AI implementations are executed on the computer apparatus 105, as shown in more detail with reference to FIG. 2, which illustrates an implementation of the disclosure.

According to embodiments, data from the machine line 100 and, if applicable, information about the product to be processed (possibly also environmental conditions) are provided to AI, which is, for example, part of the plant control system. The machine line 100 typically has an optimal or target state. This optimal state results, for example, from data (e.g. sensor values, product data, environmental conditions) that can be used as training data with which the AI (i.e. a neural network) was trained.

The neural network is trained in such a way that it can later evaluate and interpret the data incoming during operation of the machine line 100. Ideally, the neural network can initiate measures (if necessary) and intervene in the machine/plant control system.

As explained in more detail in the following description, the evaluated and interpreted data from the machine line 100 can then be used by a large language model (LLM) to form the basis for texts that are generated and output to the operator 120 as an adapted state message for the machine line 100.

The AI of the plant control system can thus proactively open up a conversation with the operator 120 by itself using the texts generated by the LLM. For this purpose, for example a message (also push notification) can be output on the HMI 110 assigned to machine line 100, such as a tablet, smartphone or operating display. The notification generated by the LLM can also directly include a dialog box in which the operator 120 can ask the AI questions. In its responses, the AI takes into account the context of the reasons for which the notification was created.

Since modern machine lines can often respond independently to faults or deviations from the target state, according to embodiments, these changes in the plant control system can also be passed to a large action model (LAM) on the basis of the data evaluated and interpreted by the AI. This LAM can then actively intervene in the plant control system. The LLM also takes into account the interventions in the plant control system by the LAM when generating the texts.

FIG. 2 shows a block diagram illustrating further details of the automatic rectification of deviations on a machine line. The plant control system 202 is a computer-assisted control system that can control the machine line 100. Examples of control operations of such a plant control system 202 include filler control, capper control, blow-molding machine control, labeling machine control, etc. In principle, more or fewer machines or modules than those listed here can also be controlled by the plant control system 202.

The plant control system 202 monitors the actual state of the machine line 100. This monitoring process involves monitoring one or more parameters of the machine line 100. This is done, for example, by sensors and/or by reading or receiving one or more machine states from machines in the machine line 100.

Various example parameters of the machine line 100 are shown on the left-hand side of FIG. 2. It is possible to subdivide the parameters into different fields, such as parameters in the machine line 100, product parameters, or parameters in the environment of the machine line 100, such as environmental parameters. Examples of parameters include temperature at a machine in the machine line 100; pressure at a machine in the machine line 100; flow rate at a machine in the machine line 100; temperature of a beverage product to be bottled; viscosity (µ) of a beverage product to be bottled; CO₂ content of a beverage product to be bottled; temperature of an environment of the machine line 100; air pressure (Pₐₜₘ) of the environment; and/or humidity (φ) of the environment of the machine line 100.

According to embodiments, the plant control system 202 can comprise an AI unit, which comprises, for example, a neural network trained to evaluate data incoming from the machine line 100 and to detect deviations from the optimal value.

The plant control system 202 (or the AI implemented therein) can then detect a deviation between the monitored actual state and an optimal state of the machine line 100. The plant control system 202 can then determine an appropriate response measure that is suitable for rectifying the deviation.

As an illustrative example on the basis of a filling machine, let us assume that the filler is a filler having various sensors (for example temperature sensors, pressure sensors, optical sensors, flowmeters or information from downstream automatic checkers) and the product is a product that is characterized by predefined values (CO₂ content, Brix content, syrup-water mixing ratio, product temperature, viscosity).

Ideally, all actual values correspond to the specified target values and the machine line 100 runs at maximum production speed, for example 100,000 containers per hour. The plant control system 202 can contain an AI model (alternatively via a cloud 105a or a local server 105b or an edge apparatus 105c) which was previously trained on the target values of this machine line 100 during commissioning of the machine line 100. During operation of the machine line 100, a plurality of sensor data and/or other state data for the machine line 100 are transmitted to the plant control system 202 by the AI.

The plant control system 202 evaluates and interprets the data. For example, it compares the data with the training data. In one possible scenario, an automatic checker located downstream of the filler establishes that too much foam is forming in the bottles and that the product to be bottled (or the foam of the product) is flowing over the opening of the bottle. In addition, a temperature sensor on the rotary distributor of the filler provides an increased temperature value. The plant control system 202 now detects (e.g. using AI) that there could be a connection between these observations. The increased temperature at the rotary distributor is heating the product being bottled more than it should. If the product has a higher temperature, it is more prone to foaming at the current production speed. This means that the plant performance must be reduced so that either the product can flow into the bottle at a lower bottling speed, the settling time after the bottling process extended, or a combination thereof may be provided.

These potential response measures are then sent to the large action model (LAM) unit 204. The LAM unit 204 derives one or more control commands from the response measure. In the example above, the LAM unit 204 can intervene in the filler control system and reduce the output of the machine line 100 to, for example, 75,000 containers per hour.

The LAM unit 204 therefore executes the one or more control commands on the machine line 100 in order to rectify or at least minimize the deviation. In addition, this intervention information is sent to a large language model (LLM) unit 206, which processes this intervention information. Processing said information by the LLM unit 206 involves generating a message about the deviation and the response measure.

According to embodiments, the intervention information includes information regarding the deviation from the actual state, information regarding the response measure, and/or information regarding the derived and executed one or more control commands.

For example, the generated message provided to the operator 120 could read: "Deviating foaming behavior has been detected for the product after bottling. One possible cause could be an increased temperature at the rotary distributor. The system performance has been temporarily reduced to positively influence the foaming behavior and, if necessary, to reduce frictional heat at the rotary distributor. ". The message can be a message in text, image, moving image, and/or audio format, or a combination thereof.

As a result, the plant control system 202 opens up communication with the operator 120 using the text itself that is generated by the LLM unit 206, and which contains all important information from the sensor data and control interventions of the LAM unit 204.

According to further embodiments, the notifications issued by the LLM unit 206 can also include instructions for the operator 120, which include repair instructions.

According to embodiments, the sensor data generated during production can be used as further training data for the plant control system 202 in order to be able to take into account deviations, for example within certain maximum tolerances, caused by wear (and thus to be able to detect wear and permit it up to a certain extent).

The functionality described above can also be provided across all machines in the machine line 100 in order to take further machines into account if a deviation occurs in a first machine in the machine line.

The embodiments of the disclosure make possible an independent and flexible machine line 100, which offers the possibility of contacting the operator 120 in case of deviations from the target value and allows enquiries to be made about the machine line 100 and its state.

The AI implementations and computer implementations used herein are broadly described below so that those skilled in the art can implement and execute the disclosure accordingly.

A large language model (LLM), as described and used herein, is a machine-learning-based system specifically trained to process and generate text data. It uses neural networks, in particular deep neural networks, to analyze the statistical and semantic relationships between words, sentences, and paragraphs. The basis of an LLM typically consists of an architecture such as the transformer model, which is capable of efficiently processing information across large sequences.

A key feature of an LLM is its training phase, in which it is trained on a large amount of text data. These data may come from various sources, such as scientific articles, technical documentation, books, or online content. During the training process, the model optimizes its weightings and parameters to make predictions about the next word in a text sequence on the basis of the previous words. This technique is called "autoregressive training". The transformer architecture, used by most LLMs, consists of a plurality of layers of self-attention mechanisms and feedforward networks. The self-attention mechanism enables the model to identify relationships between words within a context, regardless of how far apart those words are. This may be particularly important in order to correctly grasp semantic relationships and syntactic structures within a text.

After completing the training, the LLM can be used to solve various natural language processing (NLP) tasks. These include, among others, automatic text generation, answering questions, summarizing texts, machine translation, and analyzing text sentiment. The versatility of an LLM results from its ability to recognize patterns and structures in text data and apply them to new contexts. To use an LLM in the specific application of the embodiments described herein, it can be directly used or can be additionally finely fine-tuned onto a smaller, domain-specific data set. This “fine-tuning” enables the LLM to adapt to the requirements of a specific task or the documentation of machine line 100. The basic knowledge of the model is retained, while at the same time the ability to process content relating to the machine line 100 is improved.

The LLM takes entries in the form of text, which is converted into numerical vectors ("tokens"), and processes them through multiple layers of the neural network. The output also consists of numerical vectors, which are converted back into readable text. By using special optimization methods and computing resources such as GPUs or TPUs, the model is able to perform these calculations in a reasonable amount of time.

A large action model (LAM) is a machine-learning-based system that aims to plan, control, and optimize complex sequences of actions. In contrast to the large language model described above, which primarily specializes in processing and generating natural language, LAMs focus on the analysis and execution of actions in a given environment. Such models are used in fields such as robotics, autonomous driving, process control, and decision-making in dynamic systems.

The technological basis of a LAM is also based on neural networks, especially architectures that are suitable for processing temporal sequences and dynamic states. Typically, LAMs utilize variants of recurrent neural networks (RNNs), long short-term memory (LSTM) networks, or transformers that have been specifically optimized for temporal dependencies and state changes. Sensor data, state information, and context data are used as entries to predict and evaluate a series of actions.

One characteristic of LAMs is their ability to model action chains. The model not only analyzes individual actions, but also considers their consequences in different situations. The model learns a strategy or guideline to make optimal decisions in specific environments. One approach in this context is the use of reinforcement learning (RL), in which the model learns through trial and error which actions lead to positive results.

During the training process, the LAM is trained on a variety of scenarios and state changes. This involves simulating environments in which the model tries out different courses of action. Training success is evaluated through a reward function that rewards positive results and punishes negative results. In this way, the model optimizes its action strategies in order to make the most efficient and successful decisions possible.

Another technical aspect of LAMs is the integration of multi-modal data. In many applications, it is necessary to combine data from different sources such as visual sensors, acoustic signals, or mechanical control systems. LAMs are able to process such heterogeneous data streams and make complex decisions on the basis thereof. Algorithms for feature extraction and data preprocessing also play an important role in ensuring that the relevant information is interpreted correctly.

The practical application of LAMs requires a combination of model training, real-time data processing, and control systems. The model must be able to react to incoming data in near real time and suggest or directly execute appropriate actions. Both the accuracy and the speed of decision-making are of central importance. Technologically, specialized hardware platforms such as GPUs or TPUs are often used to meet the high demands on computing power.

It should be noted that the above descriptions of LLMs and LAMs are merely a general and phenomenological description, and the technical details of their modes of operation are more complex, but are known to those skilled in the field.

In the following FIGS. 3 to 6, various exemplary plant configurations for different bottle filling plants are described in which the disclosure or at least parts and aspects of the disclosure can be implemented. The description of FIGS. 3 to 6 is intended only to give a general overview of machines for which the adapted output of messages, control elements or information elements can be carried out.

FIG. 3 shows an exemplary plant configuration 1000 for PET bottles or PET containers and adhesive containers. As can be seen in FIG. 3, the plant configuration 1000 comprises the most varied modules, which form a line at the end of which the ready-filled PET containers are dispensed in the form of a bundle on pallets. Some of the modules and machines can be optional, and the disclosure is not limited to the exact shape and arrangement of the plant configurations.

The plant configuration 1000 comprises a furnace 1002 for preforms, a preform sorting system with a feeding machine 1004, and a blow-molding machine 1008. Modules 1002, 1004, and 1008 form in general a stretch blow-molding machine in which PET containers are manufactured and formed from a raw material. The produced PET containers are forwarded to a filler 1010 in which the bottles are filled. The filler can optionally comprise a rinser. Various particles such as dust, cardboard, or remains of wooden pallets can collect in the preforms during storage or transport. These can be removed with the rinser. At the end of the filler, a closer can be arranged, using which the PET containers are closed after filling.

Optionally, the plant configuration 1000 can, after the filler 1010, comprise a rotating apparatus, which is used for hot filling of the PET containers. The filled PET containers are guided to a separator 1020 and further to a drying apparatus 1024 in which the PET containers are dried via one or more conveyor belts 1016, which can also comprise a buffer 1018 for intermediate loading of filled containers.

After drying, the PET containers are conveyed to a labeling machine 1026. The labeling machine 1026 can be configured for various labeling techniques such as labeling using hot glue, cold glue, self-adhesive labels, or sleeves. After printing or labeling the PET containers, the PET containers are passed through a second drying apparatus 1028, a line distributor 1030, conveyor belts 1032, adhesive container production 1034, and a curing section to a handle applicator. In adhesive packaging production 1034, the PET containers are grouped together in certain group sizes and packaged into a pack such as a “six-pack.” In the handle applicator, a carrying handle is attached to the pack, which allows the pack to be carried comfortably. The finished packs are then accordingly arranged by a robot 1042 for layer production and packed on pallets by a palletizer 1044.

In the plant configuration 1000, so-called format trolleys or format racks can be arranged on various modules and machines in order to provide quickly changeable format sets for short changeover times and automatic tool exchange. Examples of format trolleys are the format trolley 1006 for the blow-molding machine 1008, the format trolley 1012 for the filler 1010, the format trolley 1022 for the labeling machine 1026, the format trolley 1038 for the adhesive packaging production 1034, and the format trolley 1046 for the palletizer 1044.

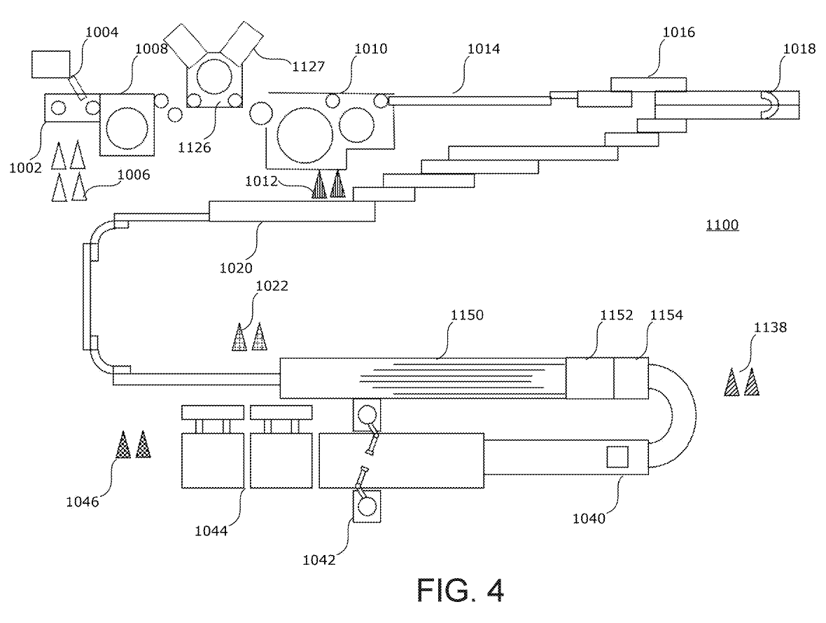

FIG. 4 shows another exemplary plant configuration 1100 for PET containers and shrink packers. The plant 1100 in FIG. 4 comprises many of the modules and machines from the plant configuration 1000 in FIG. 3, but there are some differences. The description of the modules that are already described in connection with FIG. 3 is therefore omitted for FIG. 4.

A key difference between the two exemplary plant configurations 1000 and 1100 is that the labeling machine 1126 with the labeling modules 1127 can already be installed after the blow-molding machine 1008 and before the filler 1008. For this purpose, the plant configuration 1100 can comprise six transport lanes 1150 into which the PET containers can be pushed. After the PET containers have been correspondingly pushed into one of the six lanes 1150, they are conveyed into the film wrapping module 1152 and then into the shrink tunnel 1154.

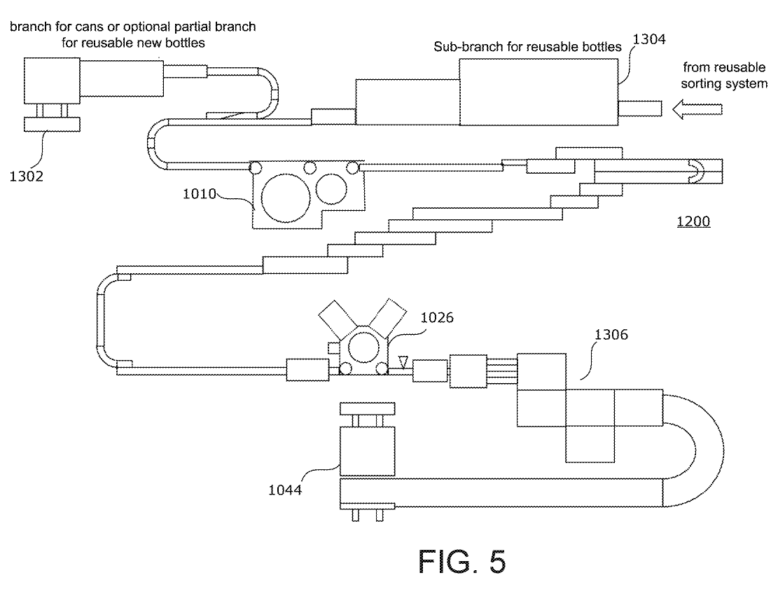

FIG. 5 shows an exemplary plant configuration 1200 for cans or glass bottles. The exemplary plant configuration 1200 from FIG. 5 again has some similarities to the plant configurations 1000 and 1100 from FIGS. 3 and 4, and the description of the plant configuration is therefore limited to the differences between the plant configurations.

As shown in FIG. 5, the exemplary plant configuration can comprise two separate feeds. A first feed, on the left in FIG. 5, shows a branch for cans or, optionally, a partial branch for reusable new bottles. The containers, i.e. cans or new bottles, are fed from a depalletizer 1302 into the machine, where they are guided via conveyor belts to the filler 1010. A second feed, on the right in FIG. 5, shows a partial branch for reusable bottles, which are introduced into the plant from a reusable sorting plant (not shown).

In the case in which the reusable bottles that have already been used are introduced into the plant 1200 via the sub-branch for reusable bottles, the reusable bottles first pass through the cleaning machine or washing machine 1304. Another possible difference of the exemplary plant configuration 1200 is the transfer packer 1306 after the labeling machine 1026. The transfer packer can sort the bottles or cans into a carton clip application or into boxes, or both.

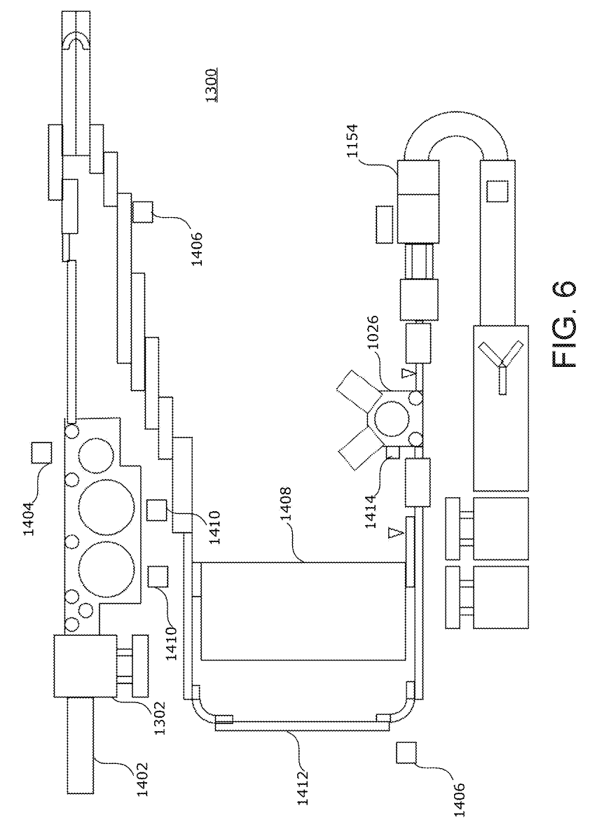

FIG. 6 shows an exemplary plant configuration 1300 for cans, in which the elements already described in the other plant configurations are not described. The cans in the plant configuration 1300 are introduced from a magazine 1402 with cans into the depalletizer 1302. The cans, after they have passed through the filler and are filled, are closed by a closure magazine 1404 and are then transported further along the plant 1400 via the conveyor belts as described above.

The optional pasteurizer 1408 can be circumvented via the bypass 1412 if it is not required. In the pasteurizer 1408, the freshly filled products can be pasteurized for preservation.

In contrast to the plant configurations 1000, 1100, and 1200, the exemplary plant configuration 1300 shows various tanks for corresponding consumables, such as the tanks 1410 with rinsing liquid and/or the filling product, and the tanks 1406 with belt lubricant. These tanks can also be contained in the above-described exemplary plant configurations. For example, the chemical products 106 that are fed from the mixer 110 to the machines can be stored in the tanks 1406 and 1410.

1. A computer-implemented method for automatically rectifying deviations on a machine line, wherein the method comprises:
monitoring an actual state of the machine line by means of a plant control system, wherein monitoring the actual state of the machine line includes monitoring one or more parameters of the machine line;
detecting a deviation between the monitored actual state and an optimal state of the machine line by means of the plant control system;
determining a response measure suitable for remedying the deviation by means of the plant control system;
deriving one or more control commands from the response measure by means of a large action model (LAM) unit;
executing the one or more control commands on the machine line by means of the LAM unit in order to remedy or minimize the deviation;
sending intervention information to a large language model (LLM) unit; and
processing the intervention information by the LLM unit, wherein processing said information by the LLM unit includes generating a message about the deviation and the response measure.

2. The method according to claim 1, wherein the intervention information comprises:
information regarding the deviation from the actual state;
information regarding the response measure; and
information regarding the derived and executed one or more control commands.

3. The method according to claim 1, wherein the plant control system comprises an artificial intelligence (AI) unit, and wherein the AI unit comprises a neural network trained to evaluate data incoming from the machine line and to detect the deviation from the optimal state.

4. The method according to claim 1, wherein the optimal state is defined from sensor-measured values in the machine line, product data relating to a product to be manufactured, and environmental conditions of the machine line.

5. The method according to claim 1, wherein the LLM unit issues the message to an operator of the machine line after the LAM unit has executed the one or more control commands, and wherein the message is a message in text, image, moving image, and/or audio format or a combination thereof.

6. The method according to claim 1, wherein monitoring the actual state involves monitoring by sensors and/or monitoring one or more machine states of machines in the machine line, and wherein the monitored parameters comprise at least one of:
a temperature at a machine in the machine line;
a pressure at a machine in the machine line;
a flow at a machine in the machine line;
a temperature of a beverage product to be bottled;
a viscosity of a beverage product to be bottled;
a CO₂ content of a beverage product to be bottled;
a temperature of an environment of the machine line;
a pressure of the environment; and/or
a humidity level of the environment of the machine line.

7. A system for automatically rectifying deviations on a machine line, wherein the system comprises:
the machine line;
a human-machine interface (HMI);
a plant control system for controlling the machine line and for reading data from the machine line, wherein the plant control system is adapted to:
monitor an actual state of the machine line, wherein monitoring the actual state of the machine line includes monitoring one or more parameters of the machine line,
detect a deviation between the monitored actual state and an optimal state of the machine line, and
determine a response measure suitable for rectifying the deviation,
a large action model (LAM) unit adapted to:
derive one or more control commands from the response measure, and
execute the one or more control commands on the machine line in order to rectify or minimize the deviation, and
a large language model (LLM) unit adapted to:
process intervention information, wherein processing said intervention information involves generating a message about the deviation and the response measure.

8. The system according to claim 7, wherein the LLM unit is further adapted to:
output the message to an operator of the machine line after the LAM unit has executed the one or more control commands, wherein the message is a message in text, image, moving image, and/or audio format or a combination thereof.

9. A computer-readable storage medium having program instructions recorded thereon that, when executed by at least one computer apparatus, configure the at least one computer apparatus for:
monitoring an actual state of a machine line using a plant control system, wherein monitoring the actual state of the machine line includes monitoring one or more parameters of the machine line;
detecting a deviation between the monitored actual state and an optimal state of the machine line using the plant control system;
determining a response measure suitable for remedying the deviation using the plant control system;
deriving one or more control commands from the response measure using a large action model (LAM) unit;
executing the one or more control commands on the machine line using the LAM unit in order to remedy or minimize the deviation;
sending intervention information to a large language model (LLM) unit; and
processing the intervention information using the LLM unit, wherein processing said information by the LLM unit includes generating a message about the deviation and the response measure.

10. The computer-readable storage medium according to claim 9, wherein the LLM unit issues the message to an operator of the machine line after the LAM unit has executed the one or more control commands, and wherein the message is a message in text, image, moving image, and/or audio format or a combination thereof.

11. The method according to claim 1, wherein the machine line fills and packages food and/or beverages.

12. The method according to claim 6, wherein the pressure of the environment is air pressure.

13. The system according to claim 7, wherein the machine line fills and packages food and/or beverages.
